(19) United States
(12) Patent Application Publication
(10) Pub. No.: US 2009/0118984 A1
(43) Pub. Date: May 7, 2009

(54) Ignition Method with Energy Conservation and Environmental Protection for Gasoline Engine

(76) Inventor: Xiuyu Che, Wei Fang (CN)

Correspondence Address: GLOBAL IP SERVICES, 7285 W. Eagle Court, Winton, CA, 95388, US

(21) Appl. No.: 11/934,859

(22) Filed: Nov. 5, 2007

(51) Int. Cl. F02D 41/30

(52) U.S. Cl. 701/105

(57) ABSTRACT

This invention makes known by a method of the ignition, which is energy conservation and environmental protection. Its characteristic is that the ignitor can fire possibly to close with the point of ignition which is under the control of digital single-chip microcomputer-controlled circuit in some working conditions. The degree of approach in proportion as the speed of operation, so that the engine output speed namely the engine output power is highest. The present invention needn't preset the so-called the best ignition curve which does not exist, but it adjusts the ignition time automatically base on the working conditions of engine. This method ensures the present system could fire at the best time in any working conditions. This technology applies to products which use gasoline engine, for example, cars, motorbikes.

### FIELD OF THE INVENTION

The present invention relates to a method which is energy conservation and environmental protection is for ignition.

### BACKGROUND OF THE INVENTION

The power of the gasoline engine is produced by mixed gas burning in the gasoline engine cylinder, and whether burning perfect or not affects driving force directly. Three conditions must be possessed for good burning, namely the good mixed gas, fully compression and the best ignition. The best ignition includes the ignition time and the ignition energy, nowadays the ignition energy has not been the problem for the ignition system. The ignition time or the advance angle becomes important, because it is one of important performance parameters of gasoline engine. Igniting too late or too early would affect economic quality and dynamic quality of gasoline engine directly. Because there is the best advance angle for the given gasoline engine working condition, the progress of ignition technology mainly expresses the control of advance angle. Nowadays the digital ignitor, which comprises the single-chip microcomputer control circle, is used in CHINA. There is a gap between the digital igniter and actual rule of the best advance angle, so the digital igniter could not achieve the best ignition in principle.

### SUMMARY OF THE INVENTION

The present invention relates to a method which is the igniter can fire possibly to close with the point of ignition under the control. The principle is that the igniter can fire possibly to close with the point of ignition under the control of digital single-chip microcomputer control circle in some random working condition. The degree of approach in proportion as the speed of operation, so that the engine output speed namely the engine output power is highest.

Because the present invention needn't preset the so-called the best ignition curve which does not exist, but it adjusts the ignition time automatically base on the working conditions of engine. This method ensures the present system could fire at the best time in any working conditions.

### DETAILED DESCRIPTION OF THE INVENTION

In order to put the present invention in practice, firstly the rotational speed of gasoline engine should be detected real time. But if the speed sensor is added, it does not only increase the cost of the system but also decreases the reliability of the system for adding the components.

The present invention detects the rotational speed of gasoline engine through timing the pulse interval time which is produced by ignition circle.

In the system, the ignition circle is the benchmark location sensor and the speed sensor. The pulse is shaped and limited by the shaping circle. At last the pulse is sent to input interface of the single-chip microcomputer.

The single-chip microcomputer sends the data of the timer (the time between two ignition pulses) to register N1 after anti-interference process and confirming process.

At the same time the timer of the single-chip microcomputer is reset and restarted. The timer begins timing again. To compare the ignition pulse interval time which is sent to register N1 with the last engine pulse interval time which is saved in the single-chip microcomputer register N2 to determine whether the gasoline engine accelerates or not.

The data of the register N1 is sent to the register N2 to prepare for next speed comparison after the above comparison. At the same time the margin between N1 and N2 is ΔW, which is sent to the register N3. When the engine is working, the ignition point should before the highest point (the time is called preignition time T).

T is not the constant, because there are various factors affecting T. So the relation betweens the ignition advance angle and the engine rotational speed is not linear, but the relation betweens the ignition advance angle and the engine working condition is an unknown curve. The ignition circle could provide the ideal ignition pulse for motorcycle at the start-up and idle stage. The ideal ignition pulse should be sent before the pulse which is produced by the ignition circle with enhancing the rotational speed of the engine (that is to say the ignition advance angle should be increased). Any curve is made from many lines according to the differential principle, and the approximate degree of the lines is related to the number of the lines.

We can suppose the preignition time T is the constant in the certain rotational speed scope of the engine by the differential principle. T can be expressed as K1=M1+M2. K1 is the single-chip microcomputer time pulse which is quantified from the preignition time T. M2 is quantitative value of the time which betweens the ignition circle sending the pulse and the pistons getting the highest point in the cylinder. M1 is the quantitative values of the time which betweens the system sending the ignition pulse and the ignition circle producing the pulse. M2 could be expressed as M2=W2/K2 approximately, W2 is the quantitative value of the time when the engine could rotate one round. Because M2 changes by ΔM2, W2 changes by ΔW2 correspondingly. K1, which is comprised by M1 and M2 is the constant, so M1 changes into −ΔM2 correspondingly, M1B=M1A−ΔM2. We preset one constant K2 when the engine starts working. Because ΔW is measurable, M1 could be calculated. Then the single-chip microcomputer could send the ignition pulse according to M1. We use the fuzzy-control principle to optimize K2 when −ΔW is smaller than some given value, so that M1 could be the optimization.

When the engine is accelerating (−ΔW is larger than some value), we can work by presetting K2. We can optimize K2 when the speed of the engine is uniform, so the engine working condition could be best. Generally speaking the time when the engine is working in uniform state is longer than the acceleration time or deceleration time, so this system could make the engine work in the best state. We can get the purpose of fuel saving. The experimental results have provided the strong evidence for this method.

What is claimed is:

1. An Ignition method with energy conservation and environmental protection for gasoline engine comprising:
setting an ignitor of a gasoline engine to fire near the point of ignition, the ignitor being under the control of digital single-chip microcomputer-controlled circle;
The degree of approach from the fire by the ignitor to the point of ignition being in proportion as the speed of operation, thereby the engine output speed namely the engine output power is highest.

2. The method according to claim 1, wherein a present system could access the gasoline engine working parameters by state and speed sensor, in the system, the single-chip microcomputer uses the fuzzy control and differential principle, and considers many factors of affecting the best ignition time, at last it sends ignition signal after calculating the best ignition time by some algorithm.

3. The method according to claim 2, wherein the present system could optimize the ignition time real time by tracing a feedback signal of engine rotational speed, so the ignition time can reach the best point of the ignition at this time.
